(19) United States
(12) Patent Application Publication
(10) Pub. No.: US 2017/0036438 A1
(43) Pub. Date: Feb. 9, 2017

(54) MANUFACTURING PROCESS OF PACKING LABELS WITH HEAT TRANSFER TECHNOLOGY WITH SEQUENTIAL ALPHANUMERIC IDENTIFICATION CODES APPLIED THEREON

(71) Applicant: TECHNOPACK INDÚSTRIA COMÉRCIO CONSULTORIA E REPRESENTAÇÕES LTDA., Cachoeirinha - RS (BR)

(72) Inventors: Patricia Ullmann Duarte Antoniuk, Porto Alegre (BR); Edgar Auler, Porto Alegre (BR); Pedro Henrique de Moura LEAL, Porto Alegre (BR); Felipe BERNARDON, Porto Alegre (BR); José Valmir de MORAIS, Gravataí (BR)

(21) Appl. No.: 14/941,068

(22) Filed: Nov. 13, 2015

(30) Foreign Application Priority Data
Aug. 6, 2015 (BR) 10 2015 018906 0

(51) Int. Cl. B41F 23/08; D21H 23/72; B65C 3/26; B41F 19/00

(52) U.S. Cl. CPC B41F 23/08; B41F 19/001; D21H 23/72; B65C 3/26

(57) ABSTRACT

The present invention refers to a manufacturing process of packing labels with Heat Transfer technology, wherein alphanumeric codes are sequentially applied over, between and/or under the layers of specific inks and varnishes which protect said area of eventual friction and wear to which they are subject during transportation, handling and productive tests.

### FIELD OF THE INVENTION

The present invention refers to a manufacturing process of packing labels with Heat Transfer technology, wherein alphanumeric codes are sequentially applied on, between and/or under the layers of specific inks and varnishes which protect said area of eventual friction and wear to which they subject during transportation, handling and productive tests.

### BACKGROUND OF THE INVENTION

Throughout the world, the packages market is becoming more stringent over the years. Manufacturers have invested in technology throughout the service life of the package, from the conception to the disposal thereof. The labels, in this context, have been the target of requirements that go beyond the merely informative function, becoming an extension of the product, with the ecological concern which revolves in the world, the label now has the same fate as the package, recycling. Therefore, the more “life” it has, the better.

Previously the labels were made of paper, what rendered the life cycle thereof very short because they were not resistant and easily detachable upon contact with water. As a consequence, there has been a demand for solutions in which the label had a longer service life or even the same service life than the package.

Over time, the papers became more resistant, with special finishes that made the label more lasting; there arose the plastics, as more resistant and practical alternative, and the self-adhesive labels that have good cost-benefit ratio. However, the self-adhesive labels are better suited to flat surfaces, with application limitations in spherical and irregular surfaces.

Nowadays there is a tendency to replace paper labels by polypropylene and PVC, especially in packs suffering the direct action of water as shampoos, detergents, bleach, among others. It is observed in the industry a gradual replacement movement of papers by self-adhesive films, because in addition to conferring a more beautiful visual appearance, they offer greater resistance to weathering.

The films have greater resistance and can have the same service life of the product and the package. Also, they have excellent graphic resolution and cost close to the labels made of paper.

Currently, there are on the market several label models resistant to the action of water and moisture, each has own and unique characteristics, being used according to the market field.

The present invention is limited to the Heat Transfer technology which is a decorative technology consisting of the direct/reverse printing on paper or polyester substrate with subsequent transfer of the image through heat and pressure to various shapes and sizes of packages and other materials. More specifically, the material is transferred to the product by means of heat and pressure.

This technology is characterized by the fact that the label seems to be part of the package (“no label look” visual), with no possibility of bubbles, wrinkles or folds in the final result. Thus, the label cannot be taken off or pulled which ensures that the mark remains on the package until it is put away by the consumer.

The prior art describes several patents that refer to the “heat transfer” process as well as labels using said technology.

U.S. Pat. No. 9,073,383 in the name of Illinois Tool Works (ITW) refers to “heat transfer” labels used for decorating, marking and branding coding in rubber products, such as hoses, power transmission belts and tires. The “heat transfer” labels described herein may be modified by an end user before the label is applied to a substrate, thereby allowing the customization of the information applied on the substrate, regardless of the amount of articles. The label may also include fixed data and a region where variable data are applied or supplied and through which the data is viewed when the label is affixed to an article or object.

In this process, several preparation steps for subsequent use are highlighted, the product must be processed and transferred in a gradual manner, it is particularly noted the removal possibility thereof upon the application of specific chemicals characterizing the reversibility of same.

U.S. Pat. No. 8 852 377 granted to TOMS RAY ALAN describes an insulate label provided for a beverage container to reduce heat transfer, particularly heat transfer by conduction from a consumer's hand to the beverage container, thereby preventing the beverage warm within the bottle in a rapid manner after the container is removed from a refrigerated or cooled environment. The label comprises a dual-ply construction, with a grid pattern placed between the layered materials. Preferably, the label comprises a film base layer secured to the container, the grid pattern comprising a ink and varnish mixture printed over the film base layer, and a laminate top layer secured to the film base layer. Air is trapped in the gaps or spaces between the protrusions created by the grid pattern, and the trapped air insulates the container. The label has a very thin profile, thereby not perceptibly changing the appearance of the container.

U.S. Pat. No. 8,709,556 describes a “heat transfer” label assembly including a “heat transfer” label including ink and adhesive, and a releasable support joined to the “heat” transfer label. The adhesive may include at least one polyketone resin and a polyamide resin. The “heat transfer” label may be used to decorate a metal article.

The process is further directed to application of colors in metal containers having an interaction in more surface layers not structurally activating the material as in the case of PET. It is noted the characterization of the term “heat transfer” only for the transfer characteristic of the process.

Patent application PI 0410639-3 refers to a label and a labeling method applicable to the labeling of bottles for carbonated beverages such as cola. This invention provides a label whereon the label inner portion identifies the product and invites the user to have access to it through a piece of rupture-resistant removable transparent outer label. In use, the entire label assembly is removed by the user during access to the inner information, thereby preparing the bottle for recycling. The label assembly becomes able to withstand the tension applied during the bottling and after bottling, the label being constructed as a homogeneous laminar assembly comprising polypropylene/polypropylene layers of different densities, wherein the stretch characteristics enable the label to accommodate these voltage loads. Such process does not address the numerical sequencing process. Furthermore, it is a reversible process completely different from the “heat transfer” process which is irreversible.

Patent Application PI 0703841-0 makes reference to gluing labels directly applicable to vitreous surfaces (glass) with reference to a pasteurization process after the application of the label, having as final product the application in beer bottles with high adhesion capacity enhanced by the addition of silane associated with hot-melt.

Patent application PI 0714513-6 granted to Illinois Tool Works details the selective thermal transfer process to a substrate having this metallic “selectivity”, i.e. the transfer of a metal adhesive layer applied to a surface that can be metallized through a carrier layer composition being activated through heat and pressure transfer.

This proposal considers the composition of layers so that the transfer is executed by means of a carrier layer, a release layer of the carrier layer, a protective layer applied to the release layer, an applied layer that can be metallized directed to the activation upon the application of heat and pressure to the label. Typically being disseminated in thermoplastic labels, cell phone cases and golf sticks and can be adhered to rigid or semi-rigid surfaces.

Patent EP 2 264 686 describes the process of printing variable information through a laser printing technology and by means of light beams different from the activation concept of “heat transfer” processes (heat radiation) to laser application process (monochromatic electromagnetic radiation).

Regarding U.S. Pat. No. 7,846,949, the instant study is developed through the no need of activation of the label surface for the application process, which minimizes the cost of energy used for the Heat Transfer process, although these excellent results are observed related to the abrasion resistance with capacity of supporting immersion test in hot or cold water for 20 to 40 minutes (ultrasonic bath).

U.S. Pat. No. 8,507,616 relates to design of an adhesive pigment named Halo-Free which confers properties to the transfer process by Heat- transfer.

Patent application US 20130071634, under development by Multi-Color Corporation, describes the process of formulating the solution thereof in Heat-transfer detailing the chemical aspects of the solution thereof.

The heat transfer process described in document US20130287972 refers to information printed in hybrid manner, that is, by the conventional process such as flexography, rotogravure or pad associated with digital processes. This document combines a digital printing process linked to conventional processes.

The art application method in heat transfer processes was also discussed in the elaboration of document WO2014126759 being presented application scenarios with unfavorable aspects and comparing application concepts.

In order to innovate, improve and/or resolve the problems of the aforementioned labels, the present invention describes a process for manufacturing package labels with the Heat Transfer technology, wherein alphanumeric codes are applied sequentially on, between and/or under the layers of inks and varnishes. Such invention was developed with the purpose of promoting relevant information to the supplier about the product manufacturing process allowing to the supplier the labeling traceability in the productive process thereof. Controlling in particular the number of uses of the bottles, providing the evaluation of aspects such as the printing quality and durability or completeness of the returnable PET bottles (REFPET).

It is also believed that this innovation will provide a greater control of the process capability thereof and a more accurate obsolescence process of REFPET bottles. For Technopack/ITW, it will be enabled the individual and dedicated monitoring of the product thereof, evaluating the same throughout the whole service life thereof, from the manufacturing process until application.

### BRIEF DESCRIPTION OF THE FIGURES

FIG. 1 represents a package label (R) having a hollow area presenting a sequential alphanumeric information code applied between the layers of inks and varnishes.

FIG. 2 represents a package label (R) having a hollow area presenting a sequential alphanumeric information code applied under or on the layers of inks and varnishes.

FIG. 3 represents the overlay scheme of inks and varnishes in a label (R) in the Heat Transfer technology.

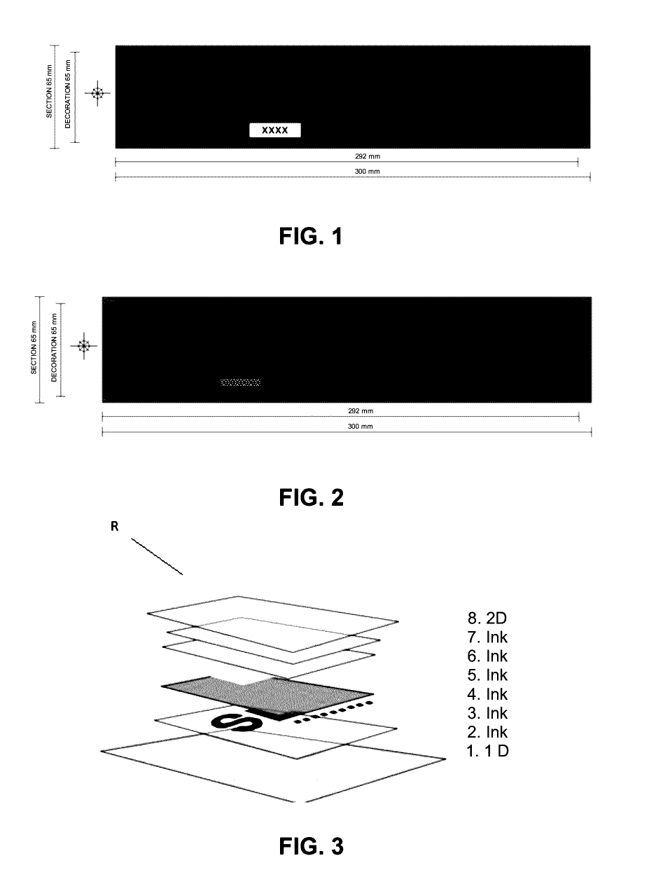

### DETAILED DESCRIPTION OF THE INVENTION

The label used in the process of the present invention comprises a substrate having a face printed in rotogravure using solvent-based inks.

The substrate is available on the market in the form of kraft, white or brown paper, with a weight ranging from 35 g/m² to 70 g/m², being subsequently improved with the application of a wax layer with a weight ranging from 1.19 up (standard unit) to 1.57 up (standard unit), in the rotogravure process prior to the application of inks or varnishes on the substrate.

The solvent-based ink used is available on the market as inks for rotogravure.

The solvents used for mixing the inks and varnishes in machines depend on the colors being applied:

If the color is white, the solvent used is a mixture at 80% ethyl acetate+20% toluene.

For the other colors, the solvent used will be 100% T-300 (38% ethyl acetate+62% n-butyl acetate).

The Protective Varnish (2D) consists of a mixture at 50% MEK (methyl ethyl ketone)+50% T-300 (38% ethyl acetate+62% n-butyl acetate).

The adhesive Varnish (1D) however consists of a mixture at 50% MEK+50% acetate.

The application area of the alphanumeric code on the label, object of the present invention, comprises printing of sequential data referring to general product information, where it will be arranged, visible to optical identification system that allows the access and recording of information.

The content of the information data may vary and it is made to order.

The confidential information data is printed by a printer using solvent-based ink.

The information data may be applied on, between or under the layers of inks and varnishes applied on the substrate.

The information data applied on the ink layers receive the application of a protective varnish layer (2D), in order to increase the resistance to friction and to caustic soda test.

The information data applied between the ink layers require a window on the label, to make it visible after application. The information data are applied to an adhesive varnish layer (1D) and a ink layer (varying the color according to the art ordered). After the application thereof on the adhesive varnish layer and the ink layer, the other inks are applied (varying according to the art defined in the order), these with a window, avoiding overlapping of the other ink layers to the information data already applied. After the application of the other ink layers, the protective varnish (2D) is applied on all art, including information data, in order to increase the resistance to friction and to the caustic soda test.

The information data applied under the layers of inks and varnishes are inserted on the verse of the label, with the protection of the other layers of inks and varnishes. The application of information data under the layers of inks or varnishes is performed in production line, during the printing or cutting process and/or in the line of label application on the final substrate. The information codes cannot have a thickness exceeding 4 microns, in order to avoid migration and label exposure to abrasion or contamination to the layers of inks and varnishes, affecting the color or finishing of the label.

The manufacturing process of the package label with the information code can occur in three different ways.

When the information code is applied on the ink layers on the label, the manufacturing process of the package label comprise the steps of:
a) application of the wax on the substrate;
b) drying this wax;
c) application of the adhesive varnish layer (1D);
d) drying this varnish layer;
e) printing ink layers on the label, according to customer's art;
f) drying the ink layers;
g) printing the information data after the application of the ink layers;
h) application of the protective varnish (2D) on the ink layers and information data; and
i) drying this protective varnish layer (2D).

When the information code is applied between the ink layers on the label, the manufacturing process of the package label comprises the steps of:
a) application of the wax on the substrate;
b) drying this wax;
c) application of the adhesive varnish layer (1D);
d) drying this varnish layer;
e) printing an ink layer on the label, according to customer's art;
f) drying the ink layer;
g) printing the information data after the application of the ink layer;
h) application of the other ink layers, with visualization window (open in the label) of the information data;
i) drying the overlapping ink layers;
j) application of the protective varnish (2D) on the ink layers and information data; and
k) drying this protective varnish layer (2D).

When the code information is applied under the ink layers on the label, the manufacturing process of the package label comprises the steps of:
a) application of the wax on the substrate;
b) drying this wax;
c) application of the adhesive varnish layer (1D);
d) drying this varnish layer;
e) printing the ink layers on the label, according to customer's art;
f) drying the ink layers;
g) application of the protective varnish (2D) on the ink layers and information data;
h) drying this protective varnish layer (2D); and
i) printing information data.

In all three cases, the confidential information is printed on the labels (R), at room temperature, through a process of rotogravure graphic printing process, using solvent-based ink.

Drying of the ink applied on the label (R), in each of the stations that apply the colors onto the substrate, varies according to the ink used.

When using solvent-based inks, the ink drying is carried out through an oven whose temperature ranges from 60-70° C. However, depending on the thickness/weight of ink applied on the substrate and printing speed, the drying temperature can be changed.

The ink application layer varies according to the customer art, the engraving type of the cylinders and tooling used during the application (knives/scraper blades—the function of which is to make the removal of the excess of inks of the application cylinders and rollers—the function of which is to promote the transfer of inks to the substrate).

When the engraving is for a flat color, the amount of ink applied is much higher. To gradients, the ink layer is smaller.

The wax composition that is applied to the substrate is unknown by Technopack, being under the wax supplier's responsibility the development of a composite suitable to rotogravure processes. When it is purchased, it is explained to the supplier the parameter use that it will be willing and normal to this process. Because it is a process already known by the suppliers, such a solution is part of the product portfolio thereof.

### Results and Tests

### Test of Caustic Soda-Resistance of the Label

### Procedure for Execution:

To prepare the solution, it was used a metal bucket large enough so that the heat transfer label labeled on the bottle was completely submerged. It was added water enough to cover the label of the bottle and the quantity, in liters, of the total added was recorded.

Then, it was added 4 g of caustic soda (NaOH) per each 1 liter of water used in the test. It's worth emphasizing that the caustic soda should always be added to water, never water to caustic soda. The reversal of this process can lead to abrupt eruptions and consequent burns.

The solution with the heating iron was heated, maintaining the temperature of 60° C. (±5° C.).

The heating iron was plugged in after being submerged in the solution, into the metal bucket, to preserve the apparatus. The bottles were filled with water so that the water height in the bottle was greater than the height of the solution and placed into the metal bucket with a weight of 2 kg above them to prevent floating.

The bottles were kept submerged for 30 minutes. During this period, the solution temperature was controlled to rely within the range (60° C.±5° C.). After 30 minutes, the bottles were removed and evaluated whether or not it has occurred detachment of the label. If not, the label is approved. If so, it is evaluated whether the affected area (where the label detached) is greater than 1 mm. If so, the label is disapproved.

The same procedure with the same materials and test settings was conducted for the labels which information code thereof is applied on, between or under the ink layers on the label.

Materials: For the execution of the test, the following materials were used:
Metal container;
Skewer type digital thermometer;
Loon type water heater;
Caustic soda solution;
PET bottle labeled with heat transfer label.

### Test Setup:

Product: PET bottle of 2 liters and 1.5 liters
Number of samples: 50 of each
Date of execution: May 23, 2015
Concentration of the caustic soda solution: 3.5% to 5%
Temperature of the solution: 60° C.±5° C.
Holding time: 2.5 hours (5×30 min)
Ambient light: D65 (Daylight approximation)

### Results and Conclusions:

In the three situations, label detachment was not evident after 5 baths of 30 minutes (total of 2.5 hours) of total immersion of the label in the caustic soda solution, even in ruptured areas.

### Friction Resistance Test of the Label

With the aid of a carbon pencil (for writing), without sharpened point, up and down movements were performed in the labeled area, at an angle of approximately 45° to the label. Such movement was performed in the entire label.

Again, it was evaluated whether or not it has occurred detachment of the label.

If not, the label is approved. If so, it is evaluated whether the affected area (where the label detached) is greater than 1 mm. If so, the label is disapproved.

The amount of 5 reps is the default, but the test can be extended to increase the reliability of the tests referred to herein.

The labels used for package designed according to the present invention showed good results in resistance to both caustic soda and friction, being capable of being used in the packing industry.

1. Process for manufacturing package labels with the heat transfer technology with the information code applied on the ink layers on the label, CARACTHERISED BY THE FACT that it comprises the steps of:
a) application of the wax on the substrate;
b) drying this wax;
c) application of the adhesive varnish layer (1D);
d) drying this varnish layer;
e) printing an ink layer on the label, according to customer's art;
f) drying the ink layers;
g) printing the information data after application of the ink layers;
h) application of the protective varnish (2D) on the ink layers and information data; and
i) drying this protective varnish layer (2D).

2. Process for manufacturing package labels with the heat transfer technology with the information code applied between the ink layers on the label, CARACTHERISED BY THE FACT THAT it comprises the steps of:
a) application of the wax on the substrate;
b) drying this wax;
c) application of the adhesive varnish layer (1D);
d) drying this varnish layer;
e) printing an ink layer on the label, according to customer's art;
f) drying the ink layer;
g) printing the information data after application of the ink layer;
h) application of the other ink layers, with visualization window (open in the label) of the information data;
i) drying the overlapping ink layers;
j) application of the protective varnish (2D) on the ink layers and information data; and
k) drying this protective varnish layer (2D).

3. Process for manufacturing package labels with the heat transfer technology with the information code applied under the ink layers on the label, CARACTHERISED BY THE FACT THAT it comprises the steps of:
a) application of the wax on the substrate;
b) drying this wax;
c) application of the adhesive varnish layer (1D);
d) drying this varnish layer;
e) printing the ink layers on the label, according to customer's art;
f) drying the ink layers;
g) application of the protective varnish (2D) on the ink layers and information data;
h) drying this protective varnish layer (2D); and
i) printing the information data.

4. Process according to claim 1, CHARACTERIZED BY THE FACT THAT the substrate is in the form of kraft, white or brown paper, with a weight ranging from 35 g/m² to 70 g/m².

5. Process according to claim 1, CHARACTERIZED BY THE FACT THAT the application of the wax generate a wax layer with a weight ranging from 1.19 up to 1.57 up.

6. Process according to claim 1, CHARACTERIZED BY THE FACT THAT the ink is a solvent-based ink for rotogravure.

7. Process according to claim 1, CHARACTERIZED BY THE FACT THAT the adhesive varnish (1D) comprises a mixture of 50% methyl ethyl ketone (MEK) and 50% ethyl.

8. Process according to claim 1, CHARACTERIZED BY THE FACT THAT the protective varnish (2D) comprises a mixture of 50% methyl ethyl ketone (MEK) and 50% T-300,
Wherein T-300 comprises a mixture of 38% ethyl acetate and 62% n-butyl acetate.

9. Process according to claim 1, CHARACTERIZED BY THE FACT THAT the drying step is performed in an oven with temperatures ranging from 60° C. to 70° C.

10. Process according to claim 1, CHARACTERIZED BY THE FACT THAT the printing of information data is performed by a printer using solvent-based ink.

11. Process according to claim 1, CHARACTERIZED BY THE FACT THAT the information data are sequential alphanumeric identification codes with a thickness equal to or less than 4 micron
